(19) United States
(12) Patent Application Publication
(10) Pub. No.: US 2025/0285627 A1
(43) Pub. Date: Sep. 11, 2025

(54) RECEIVING DEVICE FOR UP-SCALING DECODED FRAME, BASED ON NEURAL NETWORK CORRESPONDING TO CODEC INFORMATION, AND METHOD OF OPERATING RECEIVING DEVICE

(71) Applicant: SAMSUNG ELECTRONICS CO., LTD., Suwon-si (KR)

(72) Inventors: Wondeuk YOON, Suwon-si (KR); Byungjoo KIM, Suwon-si (KR); Sangho LEE, Suwon-si (KR)

(73) Assignee: SAMSUNG ELECTRONICS CO., LTD., Suwon-si (KR)

(21) Appl. No.: 19/058,432

(22) Filed: Feb. 20, 2025

(30) Foreign Application Priority Data
Mar. 6, 2024 (KR) 10-2024-0032245

(51) Int. Cl. G10L 19/002; G10L 19/16; G10L 25/30

(52) U.S. Cl. CPC G10L 19/002; G10L 19/167; G10L 25/30

(57) ABSTRACT

A receiving device is provided. The receiving device includes: a memory configured to store a plurality of encoded frames received from a transmission device; and a processor configured to receive, from the transmission device, the plurality of encoded frames from the memory, receive first codec information corresponding to parameters used to encode the plurality of encoded frames, decode the plurality of encoded frames based on the first codec information, generate a plurality of decoded frames, up-scale the plurality of decoded frames using a first super resolution (SR) neural network model corresponding to the first codec information, and generate a plurality of up-scaled frames.

### CROSS-REFERENCE TO RELATED APPLICATION

This application claims priority under 35 U.S.C. § 119 to Korean Patent Application No. 10-2024-0032245, filed on Mar. 6, 2024, in the Korean Intellectual Property Office, the disclosure of which is incorporated by reference herein in its entirety.

### BACKGROUND

The present disclosure relates to a receiving device including an audio codec, and more particularly, to a receiving device configured to up-scale a decoded frame, based on a neural network learned according to codec information used for encoding, and a method of operating the receiving device.

Research is being actively conducted to improve the quality of data transmission in wireless communication networks. For example, to ensure Quality of Service (QOS) of audio streaming in a Bluetooth network, research is being conducted to monitor network conditions by using at least one parameter (e.g., a receiver signal strength indication (RSSI), system noise level information, a power spectrum, etc.) and improve the quality of data transmission.

A scalable codec may be used to improve the quality of data transmission in wireless communication networks. The scalable codec may flexibly adjust a bitrate, a frequency band, etc., of transmission data depending on a Bluetooth network situation, and encode and transmit the data in a manner suitable for the network situation. Therefore, when a network is unstable, a transmission device may encode and transmit data, based on a low bitrate and a narrow frequency band. In this case, significant data may be lost due to the encoding. Therefore, when the network is unstable, a receiving device for restoring encoded data and generating an output signal having high resolution, and a method of the receiving device are required.

### SUMMARY

One or more example embodiments provide a receiving device for restoring an encoded frame, based on a neural network model corresponding to codec information used for encoding among a plurality of neural network models learned for each of a plurality of pieces of codec information, and generating an output signal having high resolution, and a method of operating the receiving device.

Example embodiments are not limited to addressing the technical tasks mentioned above, and other technical tasks not mentioned may be clearly understood by those skilled in the art from the description below.

According to an aspect of an example embodiment, a receiving device includes: a memory configured to store a plurality of encoded frames received from a transmission device; and a processor configured to receive the plurality of encoded frames from the memory, receive, from the transmission device, first codec information corresponding to parameters used to encode the plurality of encoded frames, decode the plurality of encoded frames based on the first codec information, generate a plurality of decoded frames, up-scale the plurality of decoded frames using a first super resolution (SR) neural network model corresponding to the first codec information, and generate a plurality of up-scaled frames.

According to another aspect of an example embodiment, a receiving device includes: an input interface configured to receive, from a transmission device, a plurality of encoded frames and codec information indicating parameters used to encode the plurality of encoded frames; and a processor configured to: generate a plurality of decoded frames based on the plurality of encoded frames; and up-scale the plurality of decoded frames using a super resolution (SR) neural network model corresponding to the codec information, and generate a plurality of up-scaled frames.

According to a further aspect of an example embodiment, a method of operating a receiving device, includes: receiving a plurality of encoded frames and codec information corresponding to parameters used to encode the plurality of encoded frames, from a transmission device; storing the plurality of encoded frames in a memory; decoding each of the plurality of encoded frames based on the codec information; generating a plurality of decoded frames; and up-scaling the plurality of decoded frames, based on a super resolution (SR) neural network model corresponding to the codec information.

### BRIEF DESCRIPTION OF DRAWINGS

The above and other aspects and features will be more apparent from the following description of example embodiments, taken in conjunction with the accompanying drawings in which:

FIG. 1 is a block diagram illustrating a wireless communication system according to an example embodiment;

FIG. 2 is a block diagram illustrating a transmission device according to an example embodiment;

FIG. 3 is a diagram to explain that a transmission device divides input data according to an example embodiment;

FIG. 4 is a block diagram illustrating a receiving device according to an example embodiment;

FIG. 5 is a block diagram illustrating an implementation example of a neural network for explaining a super resolution (SR) neural network model according to an example embodiment;

FIG. 6 is a diagram to explain an operation of a super resolution module according to an example embodiment;

FIG. 7 is a table for explaining a plurality of SR neural network models each corresponding to a plurality of pieces of codec information according to an example embodiment;

FIG. 8 is a diagram to explain a learning process of each of a plurality of SR neural network models according to an example embodiment;

FIG. 9 is a diagram to explain a delay time of an output signal according to an example embodiment;

FIG. 10 is a flowchart illustrating a method of operating a transmission device according to an example embodiment; and

FIG. 11 is a flowchart illustrating a method of operating a receiving device according to an example embodiment.

### DETAILED DESCRIPTION

Hereinafter, example embodiments are described in detail with reference to the accompanying drawings. Like components are denoted by like reference numerals throughout the specification, and repeated descriptions thereof are omitted. Embodiments described herein are example embodiments, and thus, the present disclosure is not limited thereto, and may be realized in various other forms. Each example embodiment provided in the following description is not excluded from being associated with one or more features of another example or another example embodiment also provided herein or not provided herein but consistent with the present disclosure.

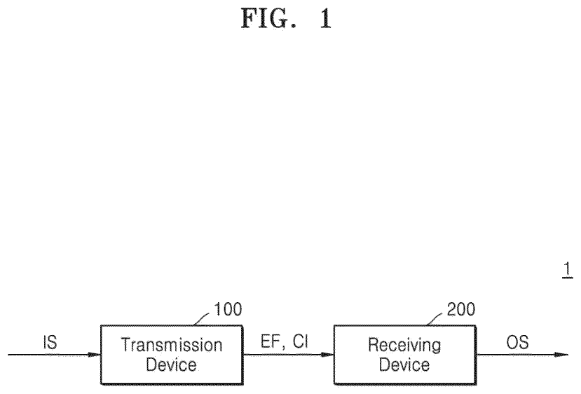

FIG. 1 is a block diagram illustrating a wireless communication system according to an example embodiment.

Example embodiments are applicable to a wireless communication system (for example, a cellular communication system such as wireless broadband (WiBro), global system for mobile communication (GSM), 5G, 6G, etc., or a short-distance communication system such as Bluetooth and near field communication (NFC)). However, example embodiments are not limited to this.

Also, various functions described below may be implemented or supported by artificial intelligence technologies or one or more computer programs, and each of the programs consists of computer-readable program code and is implemented on computer-readable media. The terms “application” and “program” refer to one or more computer programs, software components, sets of instructions, procedures, functions, objects, classes, instances, associated data, or portions thereof suitable for implementation in suitable computer-readable program code. The term “computer-readable program code” includes all types of computer code including source code, object code, and executable code. The term “computer-readable media” includes all types of media that may be accessed by a computer, such as read only memory (ROM), random access memory (RAM), a hard disk drive, a compact disk (CD), a digital video disk (DVD), or any other memories. “Non-transitory” computer-readable media exclude wired, wireless, optical, or other communication links that transmit transient electrical or other signals. The non-transitory computer-readable media include media that may permanently store data, and media that may store data and overwrite data later such as a rewritable optical disk or an erasable memory device.

Referring to FIG. 1, a wireless communication system 1 may include a transmission device 100 and a receiving device 200. Hereinafter, a description is made assuming the wireless communication system 1 is a Bluetooth communication system, but this is for convenience of explanation and example embodiments are not limited thereto.

The transmission device 100 may include an electronic device that generates image data (e.g., a moving image, a still image, raw image data, etc.) by itself or receives image data from the outside.

The transmission device 100 may receive an input signal IS from the outside. Hereinafter, for convenience of explanation, a description is made on the assumption that the input signal IS includes an audio signal, but example embodiments are not limited thereto. For example, in an example embodiment, the input signal IS may include a video signal, or an audio signal and a video signal.

For convenience of explanation, in FIG. 1, the transmission device 100 is illustrated as receiving the input signal IS from the outside, but example embodiments are not limited thereto, and the transmission device 100 may also generate the input signal IS by itself. For example, the transmission device 100 may include a smartphone, a tablet personal computer (PC), or the like. When the transmission device 100 is a smartphone, the transmission device 100 may call stored data (i.e., corresponding to the input signal IS) from a memory, and reproduce the stored data (e.g., a sound source) through the receiving device 200.

The transmission device 100 may encode and divide the input signal IS and generate a plurality of encoded frames EF corresponding to the input signal IS. Here, the input signal IS may include an analog signal, and the encoded frame EF may include a digital signal. The encoded frame EF refers to a divided portion of a bitstream corresponding to the input signal IS. Accordingly, the input signal IS may correspond to the plurality of encoded frames EF. The transmission device 100 may divide the bitstream corresponding to the input signal IS, based on a packet size. In this regard, the transmission device 100 may determine the number and size of the plurality of encoded frames EF, based on the packet size. The packet size may be determined based on a network environment. For example, the packet size may be determined based on the transmission speed of a network.

Encoding may refer to a process of generating encoded data having a smaller size than raw data (i.e., an input signal IS) from the raw data. As described above, a plurality of decoded frames generated by decoding a plurality of encoded frames (i.e., a bitstream) may be the same as or different from the raw data depending on an encoding method. For example, a decoded frame generated by decoding an encoded frame encoded according to lossless compression may be the same as the raw data (i.e., the input signal IS), but a decoded frame generated by decoding an encoded frame encoded according to lossy compression may be different from the raw data. Therefore, when a bitrate used for encoding is low, significant data may be lost from the raw data, and a corresponding decoded frame may be different from the raw data. Here, the bitrate refers to the number of samples sampled per second. In this regard, the amount of data lost may be determined depending on codec information CI used for encoding. The codec information CI may include at least one codec parameter. The codec parameter is used to refer to a parameter used for encoding, for example, the above-described bitrate, a frequency band, etc. Here, the frequency band is related to an audible frequency band and may be a standard of removing a specific frequency. For example, when the transmission device 100 performs encoding based on codec information CI corresponding to a low bitrate and a narrow frequency band, the amount of data lost may be large and accordingly, a decoding result of frames may have a great difference with the raw data. That is, there may be a great difference between an input signal and an output signal. The difference may be referred to as a quantization error.

The transmission device 100 may transmit a plurality of encoded frames EF to the receiving device 200. Also, the transmission device 100 may transmit codec information CI to the receiving device 200.

The receiving device 200 may receive a plurality of encoded frames EF from the transmission device 100. Also, the receiving device 200 may receive codec information CI from the transmission device 100. The receiving device 200 may generate an output signal OS, based on the codec information CI and the plurality of encoded frames EF. Specifically, the receiving device 200 may decode the plurality of encoded frames EF, based on the codec information CI, and generate a plurality of decoded frames, and the receiving device 200 may up-scale (or super resolution) the plurality of decoded frames, based on a super resolution (SR) neural network model corresponding to the codec information CI, and generate an output signal OS. Therefore, the receiving device 200 may generate an output signal OS with high resolution, even when the wireless communication network is unstable, that is, even when the amount of data lost due to a low bitrate and/or a narrow frequency band in an encoding process is large.

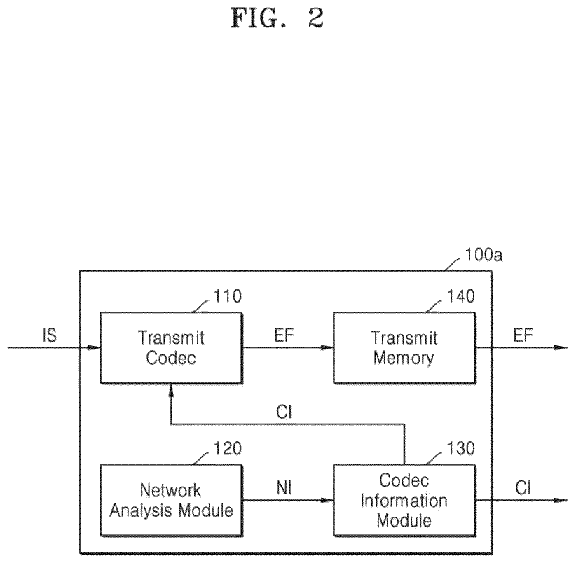

FIG. 2 is a block diagram illustrating a transmission device according to an example embodiment.

Referring to FIG. 2, a transmission device 100a may include a transmit codec (e.g., a transmit codec circuit) 110, a network analysis module (e.g., a network analysis circuit) 120, a codec information module (e.g., a codec information circuit) 130, and a transmit memory 140. The transmission device 100a corresponds to the transmission device 100 described above with reference to FIG. 1, and description previously given in this regard is omitted. According to an example embodiment, the transmission device 100a may further include other general-purpose components in addition to the components shown in FIG. 2.

Referring to FIG. 2, the transmit codec 110 may receive an input signal IS from the outside and encode the input signal IS, based on codec information CI. That is, the transmit codec 110 may operate as an encoder. The transmit codec 110 may encode and divide the input signal IS, and generate a plurality of encoded frames EF. The plurality of encoded frames EF may be sequentially provided to the transmit memory 140.

The network analysis module 120 may generate network information NI about a wireless communication network between the transmission device 100a and a receiving device (200 in FIG. 1). In general, the network information NI may include information about a network environment related to distortion, etc., caused by diffraction from interferences in a channel between the transmission device 100a and the receiving device (200 in FIG. 1), obstacles, walls, etc. For example, the network information NI may include a receiver signal strength index (RSSI), system noise level information, a power spectrum of a transmission signal, a link quality indicator (LQI), adaptive frequency hopping (AFH) channel masking, etc. The RSSI may include information related to the strength of a received signal, the LQI may be related to the quality of a communication status and include a value expressing a bit error rate (BER) as an integer between 0 and 255, and the AFH may include a hopping method used in Bluetooth and include information related to masking an unavailable channel. However, example embodiments are not limited to the above-described network information NI, and may include some of the above-described information or may further include other information.

The network analysis module 120 may generate network information NI and transmit the network information NI to the codec information module 130.

The codec information module 130 may receive network information NI from the network analysis module 120 and, based on the network information NI, the codec information module 130 may generate or select codec information CI suitable for wireless communication from predetermined codec information CI. The codec information CI may include at least one codec parameter. For example, the codec information CI may include a bitrate and a frequency band that are determined based on the network information NI. That is, in the above-described example, each of the bitrate and the frequency band may correspond to a codec parameter, and the codec information CI may include two codec parameters. In another example, when a wireless communication network environment according to the network information NI is unstable, the codec information module 130 may determine or select a less bitrate and a frequency band that is narrower than a frequency band when the wireless communication network environment is stable. In a further example, when the wireless communication network environment is relatively stable, the bitrate may be greater than about 96 kHz and the frequency band may be wider than a frequency band of about 8 kHz to about 96 kHz. In contrast, when the wireless communication network environment is relatively unstable, the bitrate may be about 96 kHz or less, and the frequency band may be narrower than a frequency band of about 8 kHz to about 96 kHz. The codec information module 130 may transfer the codec information CI to the transmit codec 110. Also, the codec information module 130 may transfer the codec information CI to the receiving device (200 in FIG. 1) as described above.

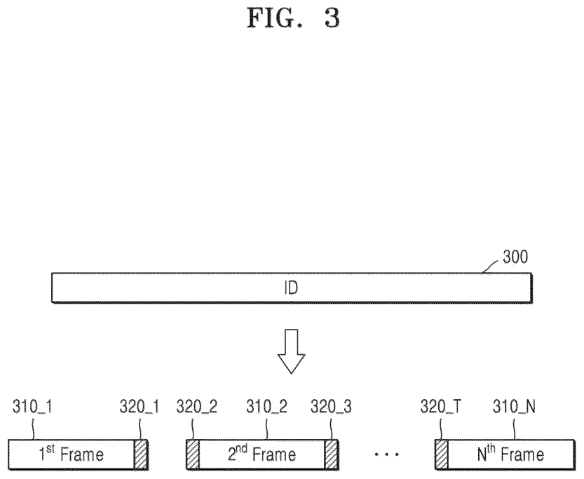

The transmit codec 110 may receive codec information CI from the codec information module 130. As described above, the transmit codec 110 may encode an input signal IS, based on the codec information CI. A description in which the transmission device 100a encodes the input signal IS and generates a plurality of encoded frames EF is given previously with reference to FIG. 1, and is omitted because a detailed description is provided below with reference to FIG. 3.

The transmit codec 110 may transfer a plurality of encoded frames EF to the transmit memory 140. The transmit memory 140 may store the plurality of encoded frames EF. The transmit memory 140 may sequentially transmit the plurality of stored encoded frames EF to a receiving device (200 in FIG. 1) through the wireless communication network.

FIG. 3 is a diagram illustrating that a transmission device divides input data according to an example embodiment.

Referring to FIG. 3, input data ID 300 may be divided into N encoded frames 310_1 to 310_N. The input data 300 may refer to a digital signal, that is, a bitstream encoding an input signal (IS in FIG. 1) described above with reference to FIG. 1.

As described above with reference to FIG. 1, the transmission device (100 in FIG. 1) may divide the input data 300, based on a packet size, and generate N encoded frames 310_1 to 310_N. Here, the N is an integer of 2 or more.

As stated above, in addition to data loss caused by encoding, a communication error may occur due to obstacles, interferences from other communication equipment, etc., in a process of transmitting and receiving a plurality of encoded frames through a wireless communication network and, owing to this, data may be lost and/or distorted. Owing to the above-described loss and/or distortion of data, phase-mismatching and/or discontinuity may occur in an output signal generated based on decoded frames. When the phase-mismatching and/or discontinuity occur in the output signal, the quality of output data may deteriorate. For example, when an input signal is an audio signal and phase-mismatching and/or discontinuity occur in an output signal, the sound quality of the audio signal may deteriorate.

To address these technical problems, the transmission device (100 in FIG. 1) may divide the input data 300 so that adjacent portions between consecutive encoded frames overlap each other. For example, the transmission device (100 in FIG. 1) may divide the input data 300 so that adjacent portions between consecutive encoded frames overlap each other by using a sliding window method. A plurality of encoded frames including the overlapped portions may be referred to as overlapped frames.

Referring to FIG. 3, the transmission device (100 in FIG. 1) may divide the input data 300 so that adjacent portions of consecutive first encoded frame 310_1 and second encoded frame 310_2 overlap each other. Accordingly, a first overlapped portion 320_1 and a second overlapped portion 320_2 may correspond to the same data. Similarly, the transmission device (100 in FIG. 1) may divide the input data 300 so that adjacent portions of consecutive second encoded frame 310_2 and third encoded frame (not shown) overlap each other. Accordingly, a third overlapped portion 320_3 and a fourth overlapped portion (not shown) may correspond to the same data. Similarly, the transmission device (100 in FIG. 1) may divide the input data 300 so that adjacent portions of consecutive (N−1)th encoded frame (not shown) and Nth encoded frame 310_N overlap each other. Accordingly, a (T−1)th overlapped portion (not shown) and a Tth overlapped portion 320_T may correspond to the same data. Here, referring to the above, it may be understood that Tis 2N-2.

Despite data loss and/or distortion occurring in a transmission and reception process, the receiving device (200 in FIG. 1) may compensate for the loss and/or distortion, based on the plurality of overlapped portions 320_1 to 320_T included in the plurality of consecutive encoded frames 310_1 to 310_N, and generate an output signal similar to the input signal.

Although the overlapped frames are illustrated with reference to FIG. 3, example embodiments are not limited thereto. In this regard, according to an example embodiment, the transmission device (100 in FIG. 1) may divide input data ID into a plurality of encoded frames, and the plurality of encoded frames may not overlap each other. That is, the plurality of encoded frames may include non-overlapped frames. In this case, in order to compensate for the data loss and/or distortion that may occur in the above-described transmission and reception process, the receiving device (200 in FIG. 1) may re-divide the received plurality of encoded frames so that each of the received plurality of encoded frames includes an overlapped portion with an adjacent encoded frame. For example, similarly to the plurality of encoded frames 310_1 to 310_N of FIG. 3, the receiving device (200 of FIG. 1) may re-divide a plurality of encoded frames and generate a plurality of re-divided frames so that sequentially received adjacent encoded frames (i.e., a previous encoded frame, a current encoded frame, and a next encoded frame) include overlapped portions. Decoding and up-scaling described below according to example embodiments may be applied to overlapped frames or be applied to non-overlapped frames. That is, example embodiments may be applied not only to the overlapped frames but also to the non-overlapped frames.

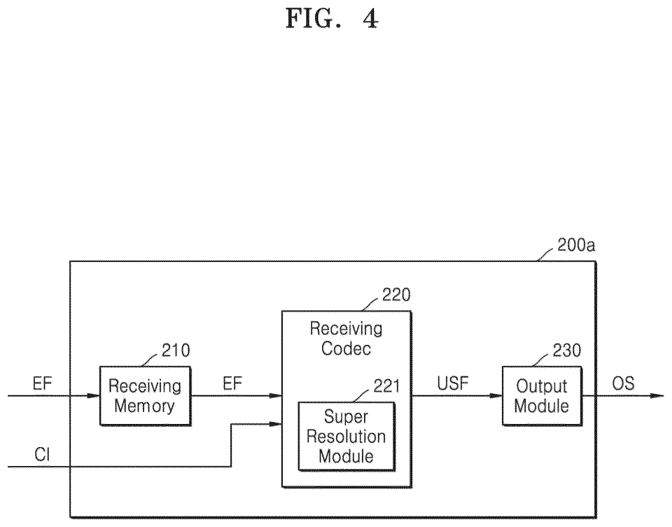

FIG. 4 is a block diagram illustrating a receiving device according to an example embodiment.

Referring to FIG. 4, a receiving device 200a may include a receiving memory 210, a receiving codec (e.g., a receiving codec circuit or a media processor) 220, and an output module (e.g., an output interface circuit) 230. The receiving device 200a corresponds to the receiving device 200 described above with reference to FIG. 1, and description previously given in this regard is omitted. According to an example embodiment, the receiving device 200a may further include other general-purpose components in addition to the components shown in FIG. 4. The transmit codec 110 of FIG. 2 and the receiving codec 220 of FIG. 4 may include audio codecs compatible with each other.

As described above, the receiving device 200a may sequentially receive a plurality of encoded frames EF from the transmission device 100 of FIG. 1. Also, the receiving device 200a may receive codec information CI from the transmission device 100 of FIG. 1.

The receiving memory 210 may store the received plurality of encoded frames EF. The receiving memory 210 may sequentially transfer the plurality of encoded frames EF to the receiving codec 220.

The receiving codec 220 may sequentially receive a plurality of encoded frames EF from the receiving memory 210, and may receive codec information CI from the transmission device 100 of FIG. 1. The receiving codec 220 may decode the encoded frame EF, based on the codec information CI, and generate a decoded frame. The receiving codec 220 may operate as a decoder. The receiving codec 220 may sequentially decode a plurality of encoded frames EF and generate a plurality of decoded frames. Decoding may be understood as an opposite process of encoding. Accordingly, the receiving codec 220 may decode the encoded frame EF, based on the codec information CI used for encoding, and generate the decoded frame.

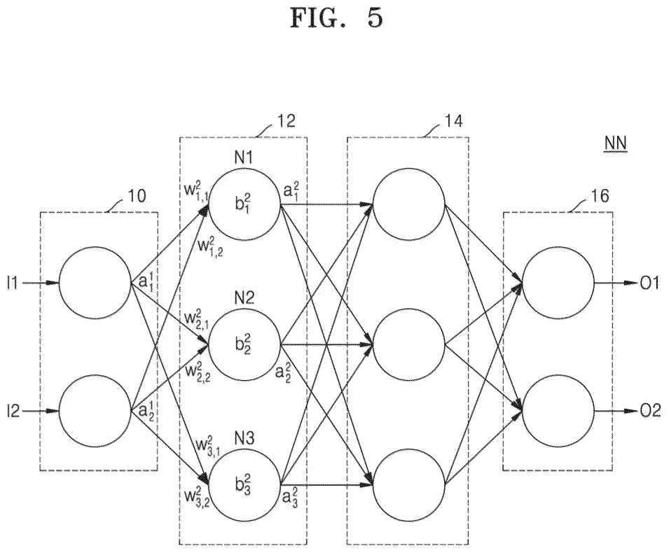

The receiving codec 220 may include a super resolution module (e.g., a super resolution circuit) 221. In FIG. 5, for convenience of explanation, the super resolution module 221 is illustrated as being included in the receiving codec 220, but example embodiments are not limited thereto, and the super resolution module 221 may be located outside the receiving codec 220. The super resolution module 221 may up-scale a decoded frame, based on an SR neural network model corresponding to the received codec information CI, and generate an up-scaled frame USF. As described above, when the wireless communication network is unstable, significant data may be lost in a process in which the transmission device (100 in FIG. 1) encodes an input signal, compared to when the wireless communication network is stable. Accordingly, an output signal corresponding to a plurality of decoded frames may be different from the input signal and thus, the quality of the output signal may deteriorate. The receiving codec 220 may up-scale a decoded frame, based on an SR neural network model corresponding to codec information CI, and generate an up-scaled frame USF. The receiving device 200a may generate an output signal OS, based on a plurality of up-scaled frames USF. Because the up-scaled frame USF generated based on the SR neural network model is obtained by compensating for the data lost in the encoding process, the output signal OS generated based on the up-scaled frame USF may be similar to the input signal. The SR neural network model may include a neural network model learned for corresponding specific codec information CI. The receiving device 200a may generate an up-scaled frame USF, based on each of a plurality of SR neural network models for each of a plurality of pieces of codec information CI determined according to a wireless communication network environment. In this regard, the receiving device 200a may apply the used SR neural network model (i.e., a weight parameter applied to the neural network model) differently in accordance with the plurality of pieces of codec information CI, and generate the up-scaled frame USF. Detailed description in this regard is provided below with reference to FIGS. 5 to 9.

The receiving codec 220 may transfer a plurality of up-scaled frames USF to the output module 230. The output module 230 may merge the plurality of up-scaled frames USF and generate an output signal OS. For example, the output module 230 may merge the plurality of up-scaled frames USF, based on a hanning window technique and/or an ORing technique, and generate an output signal OS.

The receiving codec 220 according to an example embodiment may determine whether a plurality of encoded frames EF include overlapped frames. The receiving device 200a according to an example embodiment may receive information about whether the plurality of encoded frames EF overlap each other, from the transmission device 100. Based on the determination or the information, when the plurality of encoded frames EF include non-overlapped frames, the receiving codec 220 may generate a plurality of re-divided frames (i.e., overlapped frames), based on the plurality of encoded frames EF, as described above with reference to FIG. 3.

However, example embodiments are not limited to the encoded frames EF partially overlapping each other. For example, the receiving device 200a according to an example embodiment may also perform the above-described decoding and up-scaling operations, based on a plurality of encoded frames EF including non-overlapped frames, and generate an output signal OS.

FIG. 5 is a block diagram illustrating an implementation example of a neural network for explaining an SR neural network model according to an example embodiment.

An SR neural network model may be based on a neural network NN. As described above, a super resolution module (e.g., 221 in FIG. 4) may include the SR neural network model described below.

The neural network NN of FIG. 5 is intended to aid understanding of an SR neural network model structure, and example embodiments are not limited thereto.

Referring to FIG. 5, the neural network NN may have a structure that includes an input layer, hidden layers, and an output layer. The neural network NN may perform computation, based on received input data (e.g., I1 and I2), and generate output data (e.g., O1 and O2), based on the computation result.

The neural network NN may include a deep neural network DNN or an n-layers neural network that includes two or more hidden layers. For example, the neural network NN may include a DNN that includes an input layer 10, a first hidden layer 12, a second hidden layer 14, and an output layer 16. A plurality of layers may be implemented as a convolutional layer, a fully-connected layer, a softmax layer, etc. In an example, the convolutional layer may include convolution, pooling, activation function computations, etc. Alternatively, the convolution, pooling, and activation function computations may each constitute a layer. However, as described above, the SR neural network model of example embodiments are not limited to this.

The output of the plurality of layers 10, 12, 14, and 16 may be referred to as a feature (or a feature map). The plurality of layers 10, 12, 14, and 16 may receive, as an input feature, a feature generated by a previous layer from the previous layer, compute the input feature, and generate an output feature or output signal. The feature refers to data expressing various characteristics of input data that the neural network NN may recognize.

When the neural network NN has a DNN structure, the neural network NN may include additional layers that may extract valid information, so the neural network NN may process complex data sets. It is illustrated that the neural network NN includes the plurality of four layers 10, 12, 14, and 16, but this is only an example and the neural network NN may include fewer or more layers. Also, the neural network NN may include layers of various structures different from those shown in FIG. 5.

The plurality of layers 10, 12, 14, and 16 included in the neural network NN may each include a plurality of neurons. The neurons may correspond to a plurality of artificial nodes, which are known as processing elements PE, units, or similar terms. For example, as illustrated in FIG. 5, the input layer 10 may include two neurons (nodes), and the first hidden layer 12 and the second hidden layer 14 may each include three neurons (nodes). However, this is only an example, and each layer included in the neural network NN may include a varying number of neurons (nodes).

The neurons included in each of the plurality of layers 10, 12, 14, and 16 included in the neural network NN may be connected to each other and exchange data with each other. One neuron may receive data from other neurons, perform computation, and output the computation result to other neurons.

The input and output of each of neurons (nodes such as N1, N2 and N3) may be referred to as input activation and output activation, respectively. In this regard, activation may be a parameter corresponding to both the output of one neuron and the input of neurons included in a next layer. Each of the neurons may determine its own output activation, based on output activations (for example, a₁¹, a₂¹, a₁², a₂², a₃², etc.), weights (for example, w_{1,1}², w_{1,2}², w_{2,1}², w_{2,2}², w_{3,1}², w_{3,2}², etc.) and biases (for example, b₁², b₂², b₃², etc.) that are received from neurons included in a previous layer. The weight and the bias may be parameters (for example, weight parameters) used to calculate output activation in each neuron, and the weight may be a value assigned to a connection relationship between the neurons, and the bias may be a weight related to each neuron. The neural network NN may determine the parameters such as the weight and the bias, based on a loss value generated by a loss function, as described above with reference to FIG. 2. Specifically, the SR neural network model may update the weight and the bias, based on an output frame and a ground truth (GT) frame generated based on a decoded frame. For example, the weight parameters may be updated so that the loss function is minimized for the output frame and the GT frame. Updating the weight and/or the bias (i.e., updating the parameters) may be referred to as learning the SR neural network model.

The SR neural network model may be learned separately for at least two codec parameters included in codec information. However, the SR neural network model of example embodiments is not limited to this, and may be learned by considering both of at least two codec parameters. Therefore, auto-encoder, U-NET, full-connected, etc., may be used as the SR neural network models. The SR neural network model includes a neural network model that has been pre-trained (or previously learned) in an external device. That is, the receiving device (200 in FIG. 1) may store weight parameters of a neural network model pre-trained for at least one codec parameter or learned considering each or both of at least two codec parameters, and the neural network model to which the weight parameters may be applied. Compared to a neural network model that may perform up-scaling for all of a plurality of pieces of codec information (i.e., may use a plurality of the same weight parameters for all of the plurality of pieces of codec information), the neural network model stored in the receiving device (200 in FIG. 1) may include a lightweight neural network model.

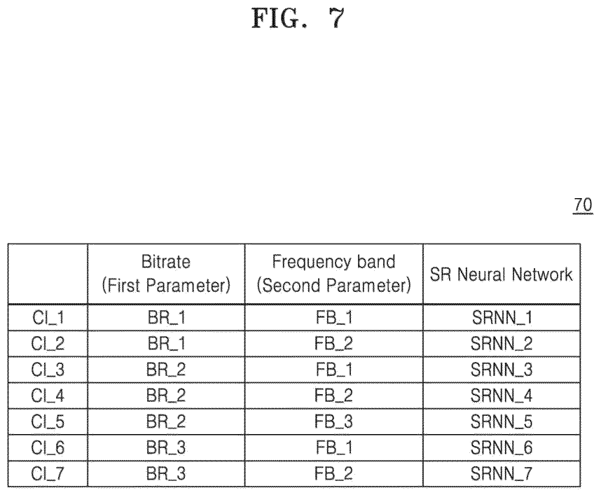

The super resolution module (e.g., 221 in FIG. 4) may include a plurality of SR neural network models each corresponding to a plurality of pieces of codec information that may be used for encoding. The plurality of SR neural network models may mean that different weight parameters are applied to one neural network structure. In this regard, the super resolution module (e.g., 221 in FIG. 4) may up-scale a decoded frame, based on a neural network to which a weight parameter corresponding to codec information used to encode an input signal is applied. Similarly, learning the plurality of SR neural network models may mean updating a weight parameter corresponding to each of the plurality of pieces of codec information. The SR neural network model may be implemented by an external electronic device (e.g., a GPU server) having a large resource rather than a receiving device (200 in FIG. 1). Accordingly, the receiving device (200 in FIG. 1) may only store a weight parameter and a neural network model that are derived through the external electronic device. For example, the receiving memory (210 in FIG. 4) may store the weight parameter and the neural network model. Here, the weight parameter corresponds to codec information used to encode an input signal as described above. Accordingly, the receiving device (200 in FIG. 1) may store a plurality of weight parameters each corresponding to a plurality of pieces of codec information that may be used in different wireless communication network environments. Regarding a plurality of SR neural network models, a description is provided below with reference to FIG. 7.

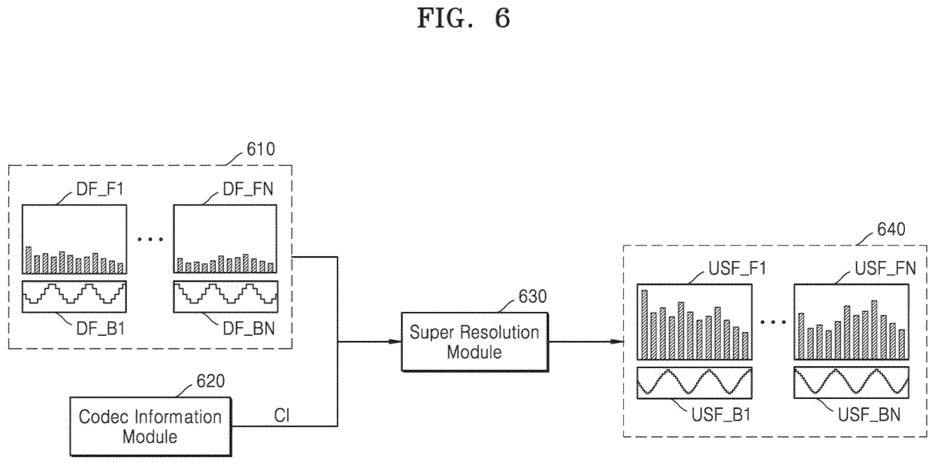

FIG. 6 is a diagram to explain an operation of a super resolution module according to an example embodiment.

As described above, a super resolution module 630 may up-scale N decoded frames 610, based on an SR neural network model, and generate N up-scaled frames 640. Here, the SR neural network model used may include a neural network model to which weight parameters corresponding to codec information CI used for encoding are applied. As described above, a codec information module 620 included in a transmission device may generate the codec information CI, based on network information. Also, as described above, the N decoded frames 610 may be generated based on the codec information CI.

The N decoded frames 610 and the N up-scaled frames 640 of FIG. 6 have been expressed in terms of a bitrate and a frequency band that are included in the codec information CI. Referring to FIG. 6, a first decoded frame frequency DF_F1 indicates a frequency band of the first decoded frame, and a first decoded frame bitrate DF_B1 indicates a bitrate of the first decoded frame. Similarly, an Nth decoded frame frequency DF_FN indicates a frequency band of the Nth decoded frame, and an Nth decoded frame bitrate DF_BN indicates a bitrate of the Nth decoded frame. Referring to the first decoded frame frequency DF_F1, the first decoded frame bitrate DF_B1, the Nth decoded frame frequency DF_FN, and the Nth decoded frame bitrate DF_BN, it may be checked that data lost due to encoding has not been restored.

In contrast, referring to a first up-scaled frame frequency USF_F1 indicating a frequency band of the first up-scaled frame, a first up-scaled frame bitrate USF_B1 indicating a bitrate of the first up-scaled frame, an Nth up-scaled frame frequency USF_FN indicating a frequency band of the Nth up-scaled frame, and an Nth up-scaled frame bitrate USF_BN indicating a bitrate of the Nth up-scaled frame, it may be checked that some of data lost in an encoding process have been restored.

Therefore, as described above, the super resolution module 630 may perform the up-scaling for restoring the data lost in the encoding process, for the N decoded frames 610, and generate the N up-scaled frames 640. Accordingly, an output signal generated based on the N up-scaled frames 640 may be similar to an input signal.

FIG. 7 is a table for explaining a plurality of SR neural network models respectively corresponding to a plurality of pieces of codec information according to an example embodiment.

Table 70 of FIG. 7 shows a bitrate and a frequency band that are included in each of first codec information CI_1 to seventh codec information CI_7, and shows a first SR neural network model SRNN_1 to a seventh SR neural network model SRNN_7 respectively corresponding to the first codec information CI_1 to the seventh codec information CI_7.

Referring to FIG. 7, each of the first codec information to the seventh codec information CI_1 to CI_7 has been expressed as including two codec parameters. However, this is for convenience of explanation, and as described above, example embodiments are not limited thereto. For example, the codec information may further include a bit depth related to the number of bits used to indicate one audio sample, and/or a codec parameter related to the number of channels.

Referring to FIG. 7, the first codec information CI_1 may include a first bitrate BR_1 and a first frequency band FB_1, and the first codec information CI_1 may correspond to the first SR neural network model SRNN_1. With reference to the above, a bitrate and a frequency band included in each of the second codec information CI_2 to the seventh codec information CI_7 and a corresponding SR neural network model may be understood.

Each of the first codec information CI_1 to the seventh codec information CI_7 may be composed of a combination of one of a first bitrate BR_1 to a third bitrate BR_3 and one of a first frequency band FB_1 to a third frequency band FB_3.

The codec information may include at least one codec parameter, and an SR neural network model may be selected based on at least one of the at least one codec parameter included in the codec information. That is, the codec information may include more codec parameters than the number of codec parameters shown in FIG. 7, and an SR neural network model may be selected based on some of these codec parameters. In this regard, the SR neural network model may be selected based on some of a plurality of codec parameters used for encoding. The codec parameters considered for selecting the SR neural network model may include parameters having a greater correlation with lost data than other codec parameters.

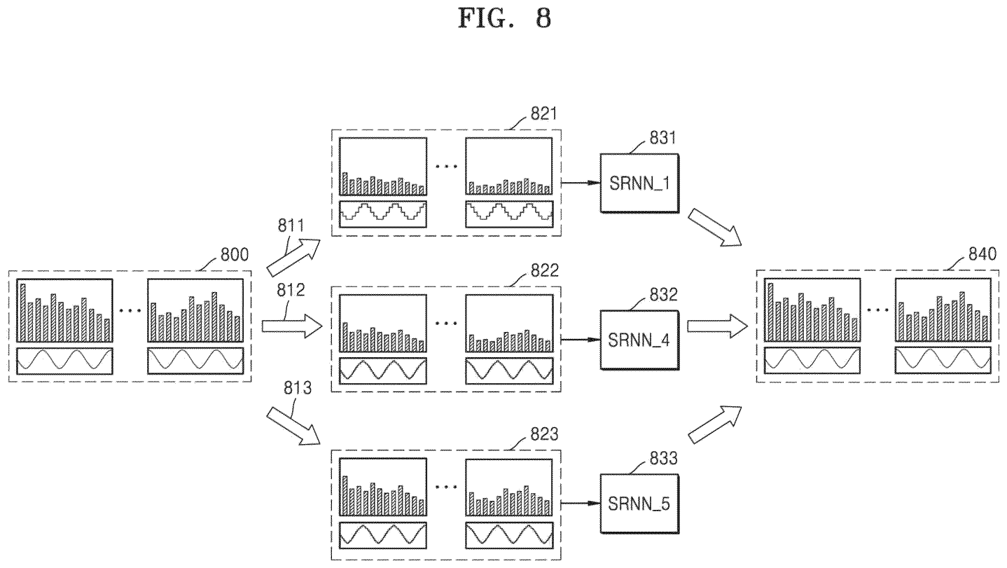

FIG. 8 is a diagram to explain a learning process of each of a plurality of SR neural network models according to an example embodiment.

FIG. 8 is a diagram to explain a learning of the SR neural network model. FIG. 8 may be described with reference to FIG. 7. Also, FIG. 8 may be understood with reference to the description of the frame bitrates DF_B1 and USF_B1 of FIG. 6 and the frame frequency bands DF_F1 and USF_F1 of FIG. 6.

For convenience of explanation, it is assumed that, among the first bitrate BR_1 to the third bitrate BR_3 of FIG. 7, the first bitrate BR_1 of FIG. 7 is lowest and the third bitrate BR_3 of FIG. 7 is highest. For example, the first bitrate BR_1 of FIG. 7 may be about 32 kHz, the second bitrate BR_2 of FIG. 7 may be about 48 kHz, and the third bitrate BR_3 of FIG. 7 may be about 96 kHz. Similarly, it is assumed that, among the first frequency band FB_1 to the third frequency band FB_3 of FIG. 7, the first frequency band FB_1 of FIG. 7 is lowest and the third frequency band FB_3 of FIG. 7 is highest. For example, the first frequency band FB_1 of FIG. 7 may be about 8 kHz to about 32 kHz, the second frequency band FB_2 of FIG. 7 may be about 8 kHz to about 48 kHz, and the third frequency band FB_3 of FIG. 7 may be about 8 kHz to about 96 kHz.

As described above, a learning of the SR neural network model may be performed not in a receiving device (200 in FIG. 1) but in an external device having large resources. The receiving device (200 in FIG. 1) does not require many resources because the receiving device 200 stores weight parameters, and an SR neural network model, of an SR neural network provided by the external device. Accordingly, example embodiments may be applied even when the receiving device (200 in FIG. 1) cannot provide many resources and cannot perform processing on many resources. For example, when a transmission device (100 in FIG. 1) is a smartphone and the receiving device (200 in FIG. 1) is wireless earphones, the receiving device (200 in FIG. 1) may provide audio having improved sound quality to a user by using fewer resources.

Referring to FIG. 8, the above-described external device may receive codec information CI, and encode and decode an input signal 800, based on different the codec information. For example, the external device may receive the first codec information CI_1 from the transmission device, and encode and decode (811) the input signal 800, based on the first codec information CI_1 of FIG. 7, and generate a plurality of first decoded frames 821. For example, the external device may receive the fourth codec information CI_4 from the transmission device, and encode and decode (812) the input signal 800, based on the fourth codec information CI_4 of FIG. 7, and generate a plurality of second decoded frames 822. For example, the external device may receive the fifth codec information CI_5 from the transmission device, and encode and decode (813) the input signal 800, based on the fifth codec information CI_5 of FIG. 7, and generate a plurality of third decoded frames 823.

The external device may up-scale the first decoded frames 821, based on the first SR neural network model SRNN_1 corresponding to the first codec information (CI_1 in FIG. 7), and generate a plurality of first up-scaled frames. The external device may determine first weight parameters of the first SR neural network model SRNN_1 so that the difference between the plurality of first up-scaled frames and a plurality of GT frames 840 is minimized.

Similarly, the external device may up-scale the second decoded frames 822, based on the fourth SR neural network model SRNN_4 corresponding to the fourth codec information (CI_4 in FIG. 7), and generate a plurality of second up-scaled frames. The external device may determine fourth weight parameters of the fourth SR neural network model SRNN_4 so that the difference between the plurality of second up-scaled frames and the plurality of GT frames 840 is minimized. Referring to the above, determining fifth weight parameters of the fifth SR neural network model SRNN_5 may be understood.

As described above with reference to FIG. 8, by determining weight parameters corresponding to each of a plurality of pieces of codec information that may vary depending on a network environment, it is possible to more efficiently and accurately restore lost data than when determining weight parameters corresponding to all codec information. Also, because the SR neural network model may include a neural network model having a simpler structure than that of an SR neural network model for all codec information, the receiving device (200 in FIG. 1) may perform a relatively small amount of computations to generate an up-scaled frame.

Referring to FIG. 8, in order to emphasize the applying of different weight parameters, structures of a first SR neural network model SRNN_1, a fourth SR neural network model SRNN_4, and a fifth SR neural network model SRNN_5 are the same as each other. For example, the number of layers of the first SR neural network model SRNN_1, the fourth SR neural network model SRNN_4, and the fifth SR neural network model SRNN_5 may be the same as the number of neurons included in the layers.

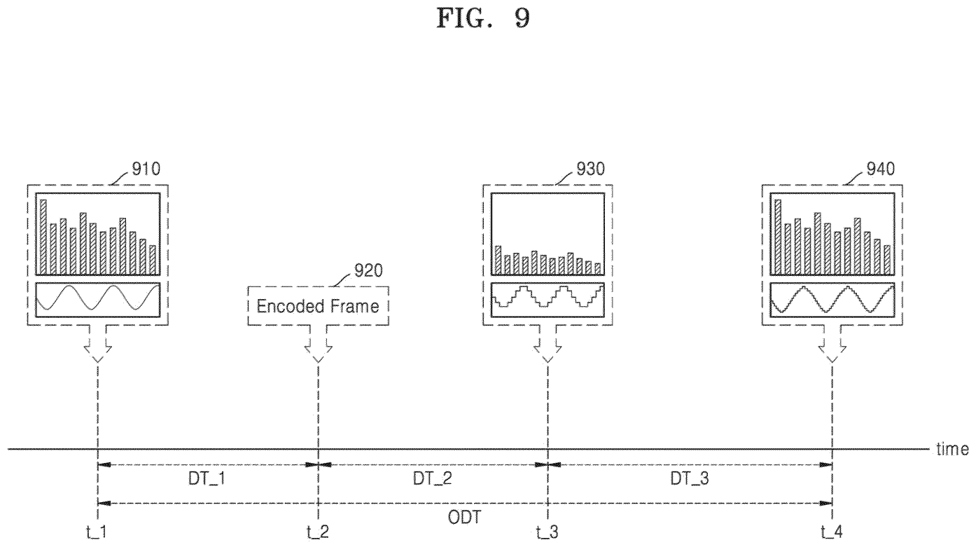

FIG. 9 is a diagram to explain a delay time of an output signal according to an example embodiment.

In FIG. 9, a description is made with reference to the operations of a transmission device (100 in FIG. 1) and a receiving device (200 in FIG. 1) described above with reference to FIGS. 1 to 8. As described above, a plurality of frames may be sequentially encoded, transmitted and/or received, decoded, and up-scaled. The time (hereinafter, referred to as a delay time) required for encoding, transmitting and/or receiving, decoding, and up-scaling one frame is described below with reference to FIG. 9.

Referring to FIG. 9, the transmission device (100 in FIG. 1) may receive an input signal 910 from the outside at a first time point t_1. As described above, the transmission device (100 in FIG. 1) may encode and divide the input signal 910, based on codec information determined based on network information, and generate an encoded frame 920 at a second time point t_2. Accordingly, during a first delay time DT_1 the transmission device (100 in FIG. 1) may encode and divide the input signal 910, and generate the encoded frame 920.

The transmission device (100 in FIG. 1) may transmit the encoded frame 920 to the receiving device (200 in FIG. 1), and the receiving device (200 in FIG. 1) may receive the encoded frame 920 from the transmission device (100 in FIG. 1) and generate a decoded frame 930 at a third time point t_3. Accordingly, a second delay time DT_2 may be required for transmitting and/or receiving and decoding the encoded frame 920. As described above, the transmission device (100 in FIG. 1) may transmit codec information to the receiving device (200 in FIG. 1). The receiving device (200 in FIG. 1) may perform decoding, based on the codec information.

The receiving device (200 in FIG. 1) may up-scale the decoded frame 930, and generate an up-scaled frame 940 at a fourth time point t_4. Accordingly, the receiving device (200 in FIG. 1) may up-scale the decoded frame 930 during a third delay time DT_3 and generate the up-scaled frame 940.

As described above with reference to FIG. 9, an output delay time ODT required for performing a procedure of receiving one frame from the transmission device (100 in FIG. 1), encoding the frame, transmitting and/or receiving the frame, decoding the frame, up-scaling the frame, and outputting an output signal may include the sum of at least the first delay time DT_1, the second delay time DT_2 and the third delay time DT_3. For convenience of explanation, in FIG. 9, the output delay time ODT is illustrated as the sum of the first delay time DT_1, the second delay time DT_2, and the third delay time DT_3, but the output delay time ODT may further include other times, such as a delay time required for merging consecutive up-scaled frames. As described above, the receiving device (200 in FIG. 1) may merge a plurality of consecutive up-scaled frames and generate an output signal, so at least two up-scaled frames are required for the output signal to be output from the receiving device (200 in FIG. 1). Therefore, the maximum delay time of the output signal output from the receiving device (200 in FIG. 1) may be twice the output delay time ODT. Therefore, an actual delay time of the output signal output from the receiving device (200 in FIG. 1) may be twice or more than the sum of the first delay time DT_1, the second delay time DT_2, and the third delay time DT_3.

In contrast, when a delay time is minimized, for example, when a current frame is up-scaled and simultaneously a next frame is decoded, the minimum delay time of an output signal output from the receiving device (200 in FIG. 1) may be the output delay time ODT.

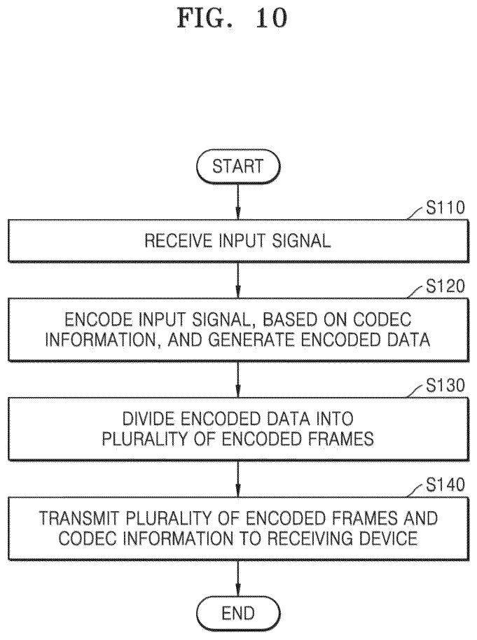

FIG. 10 is a flowchart illustrating a method of operating a transmission device according to an example embodiment.

Referring to FIG. 10, in operation S110, the transmission device (100 in FIG. 1) may receive an input signal from the outside.

In operation S120, the transmission device (100 in FIG. 1) may encode the input signal, based on codec information, and generate encoded data. As described above, the codec information may be determined according to a network environment between the transmission device and a receiving device. The codec information may include at least one codec parameter. For example, the codec information may include a bitrate and a frequency band corresponding to the codec parameter.

In operation S130, the transmission device (100 in FIG. 1) may divide the encoded data into a plurality of encoded frames.

In operation S140, the transmission device (100 in FIG. 1) may transmit the plurality of encoded frames and the codec information to the receiving device. The transmission device may sequentially provide the plurality of encoded frames to the receiving device.

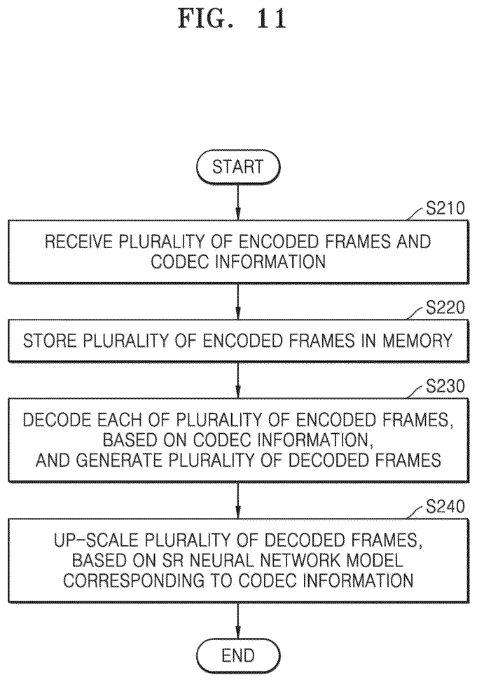

FIG. 11 is a flowchart illustrating a method of operating a receiving device according to an example embodiment.

Referring to FIG. 11, in operation S210, the receiving device (200 in FIG. 1) may receive a plurality of encoded frames and codec information from a transmission device (100 in FIG. 1). The receiving device (200 in FIG. 1) may receive the plurality of encoded frames and the codec information used for encoding an input signal, from the transmission device (100 in FIG. 1).

In operation S220, the receiving device (200 in FIG. 1) may store the plurality of encoded frames in a memory.

In operation S230, the receiving device (200 in FIG. 1) may decode each of the plurality of encoded frames, based on the codec information, and generate a plurality of decoded frames.

In operation S240, the receiving device (200 in FIG. 1) may up-scale the plurality of decoded frames, based on an SR neural network corresponding to the codec information.

In some embodiments, each of the components represented by a block as illustrated in FIGS. 1, 2, 4-6 and 8 may be implemented as various numbers of hardware and/or firmware structures that execute respective functions described above, according to example embodiments. For example, at least one of these components may include various hardware components including a digital circuit, a programmable or non-programmable logic device or array, an application specific integrated circuit (ASIC), transistors, capacitors, logic gates, or other circuitry using use a direct circuit structure, such as a memory, a processor, a logic circuit, a look-up table, etc., that may execute the respective functions through controls of one or more microprocessors or other control apparatuses. Also, at least one of these components may further include or may be implemented by a processor such as a central processing unit (CPU) that performs the respective functions, a microprocessor, or the like. Functional aspects of example embodiments may be implemented in algorithms that execute on one or more processors. Furthermore, the components, elements, modules or units represented by a block or processing steps may employ any number of related art techniques for electronics configuration, signal processing and/or control, data processing and the like.

While aspects of example embodiments have been particularly shown and described, it will be understood that various changes in form and details may be made therein without departing from the spirit and scope of the following claims.

What is claimed is:

1. A receiving device comprising:
a memory configured to store a plurality of encoded frames received from a transmission device; and
a processor configured to receive the plurality of encoded frames from the memory, receive, from the transmission device, first codec information corresponding to parameters used to encode the plurality of encoded frames, decode the plurality of encoded frames based on the first codec information, generate a plurality of decoded frames, up-scale the plurality of decoded frames using a first super resolution (SR) neural network model corresponding to the first codec information, and generate a plurality of up-scaled frames.

2. The receiving device of claim 1, wherein the first codec information is selected from among N pieces of codec information (N being an integer of 2 or more), and
wherein the memory is further configured to further store a plurality of weight parameter groups, the plurality of weight parameter groups comprising first weight parameters to Nth weight parameters respectively corresponding to the N pieces of codec information, and an SR neural network model.

3. The receiving device of claim 2, wherein the processor is further configured to obtain the first SR neural network model by applying the first weight parameters corresponding to the first codec information to the SR neural network model.

4. The receiving device of claim 3, wherein the first codec information comprises a plurality of first codec parameters corresponding to a first wireless communication network environment between the transmission device and the receiving device, and
wherein the first weight parameters correspond to a result of separately learning the SR neural network model for each of the plurality of first codec parameters.

5. The receiving device of claim 4, wherein the plurality of first codec parameters comprises a first bitrate and a first frequency band.

6. The receiving device of claim 3,
wherein the first codec information comprises a plurality of codec parameters corresponding to a first wireless communication network environment between the transmission device and the receiving device, and
wherein the first weight parameters are selected based on at least one of a plurality of first codec parameters comprised in the first codec information.

7. The receiving device of claim 1, wherein the first codec information comprises at least one first codec parameter corresponding to a first wireless communication network environment between the transmission device and the receiving device.

8. The receiving device of claim 7, wherein the first codec information comprises any one or any combination of a first bitrate and a first frequency band.

9. A receiving device comprising:
an input interface configured to receive, from a transmission device, a plurality of encoded frames and codec information indicating parameters used to encode the plurality of encoded frames; and
a processor configured to:
generate a plurality of decoded frames based on the plurality of encoded frames; and
up-scale the plurality of decoded frames using a super resolution (SR) neural network model corresponding to the codec information, and generate a plurality of up-scaled frames.

10. The receiving device of claim 9, wherein the codec information comprises a plurality of codec parameters corresponding to a wireless communication network environment between the transmission device and the receiving device,
wherein the receiving device further comprises a memory configured to store a plurality of weight parameters of a neural network model previously learned for at least one of the plurality of codec parameters, and
wherein the SR neural network model uses the plurality of weight parameters stored in the memory.

11. The receiving device of claim 10, wherein the plurality of weight parameters correspond to a result of separately learning the neural network model for each of the plurality of codec parameters.

12. The receiving device of claim 10, wherein the plurality of codec parameters comprises a bitrate and a frequency band.

13. The receiving device of claim 9, wherein the plurality of encoded frames comprise non-overlapped frames, and
wherein the processor is further configured to re-divide each of the plurality of encoded frames so that each of the plurality of encoded frames comprises a portion overlapping an adjacent encoded frame, and generate a plurality of re-divided frames.

14. The receiving device of claim 13, wherein the processor is further configured to decode the plurality of re-divided frames, based on the codec information, and generate the plurality of decoded frames.

15. A method of operating a receiving device, the method comprising:
receiving a plurality of encoded frames and codec information corresponding to parameters used to encode the plurality of encoded frames, from a transmission device;
storing the plurality of encoded frames in a memory;
decoding each of the plurality of encoded frames based on the codec information;
generating a plurality of decoded frames; and
up-scaling the plurality of decoded frames, based on a super resolution (SR) neural network model corresponding to the codec information.

16. The method of claim 15, wherein the SR neural network model uses a plurality of weight parameters of a neural network that is previously learned and corresponds to the codec information.

17. The method of claim 15, wherein the parameters comprise a bitrate and a frequency band.

18. The method of claim 15, wherein each of the plurality of encoded frames comprises a portion overlapping an adjacent encoded frame.

19. The method of claim 15, wherein the plurality of encoded frames comprise non-overlapped frames.

20. The method of claim 19, wherein the generating of the plurality of decoded frames comprises:
re-dividing each of the plurality of encoded frames so that each of the plurality of encoded frames comprises a portion overlapping an adjacent encoded frame, and generating a plurality of re-divided frames; and
decoding the plurality of re-divided frames, based on the codec information, and generating the plurality of decoded frames.
